(19) United States
(12) Patent Application Publication
(10) Pub. No.: US 2019/0278562 A1
(43) Pub. Date: Sep. 12, 2019

(54) SYSTEM AND METHOD FOR VOICE CONTROL OF A COMPUTING DEVICE

(71) Applicant: John Hien Tang, Oakland, CA (US)

(72) Inventor: John Hien Tang, Oakland, CA (US)

(21) Appl. No.: 15/913,989

(22) Filed: Mar. 7, 2018

(51) Int. Cl. G06F 3/16; G10L 15/22; G10L 15/02

(52) U.S. Cl. CPC G06F 3/167; G10L 15/22; G10L 2015/027; G10L 2015/223; G10L 15/02

(57) ABSTRACT

A control system is disclosed. The control system has a voice recognition module, comprising computer-executable code stored in non-volatile memory, a processor, a voice recognition device, and a user interface. The voice recognition module, the processor, the voice recognition device, and the user interface are configured to use the voice recognition device to generate real-time user voice data, detect a first user command uttered beginning at a first time and a second user command uttered beginning at a second time based on the real-time user voice data, move an element of the user interface in a first state for a first time period starting after the first user command is uttered and ending at the second time, and move the element of the user interface in a second state for a second time period starting at the second time and ending when an utterance of the second user command ends.

### TECHNICAL FIELD

The present disclosure generally relates to a computing device control system and method, and more particularly to a voice-controlled computing device control system and method.

### BACKGROUND

The current state of voice-controlled operation of computing devices is command-driven operation. In addition to voice assistant systems that control an application based on a user voice command (e.g., such as “Siri” and similar systems), voice-operated systems may also allow a user to directly control the operation of a computing device (e.g., operation of a cursor or other element) using voice commands. For example, voice-operated systems such as “Bixby” may be used as a substitute for controlling a user interface directly with a user's hands.

For example the command “start” may be uttered by a user to start a process or application, followed by saying a specific name for a given action, process, or application. For example, “start timer” may initiate a timer operation. Navigation-based commands such as “up”, “down”, “left”, and “right” may also be used. These commands operate based on a complete utterance of each command in order for a system to recognize the command and respond according to the user's intention and within parameters based on system programming.

For example, conventional voice-operated systems may control scrolling down a webpage by repeatedly scrolling down a page by a predetermined amount such as one page length in response to a command of “scroll.” For example, the user may repeatedly say the command “scroll” to continue the scrolling operation (e.g., scrolling one page length per command uttered by the user). Many users, though, may find repeatedly saying the same word to be tedious. For example, a user may repeatedly say “scroll” many times until a desired object on a webpage is reached (e.g., a video), and then say the first few words of a title of the object (e.g., the title of a video) to load the video.

Although the conventional voice-operated systems work in some situations, they are unreliable in certain situations (e.g., for certain webpage and media formats) and may be cumbersome and frustrating for a user to perform certain functions. For example, although saying the name of a video should be simple in theory, many videos have long titles including the same words and/or nonsensical words, and may be difficult in practice to succinctly and uniquely identify a given object based on recitation of a title (e.g., a video title). Also, many conventional systems involve fully reciting punctuation marks, which may be cumbersome or tedious for a user (e.g., “nappy %?! kitty cats!” would be recited as “exclamation mark-exclamation mark-happy-percentage sign-question mark-exclamation mark-kitty-cats-exclamation mark”).

The exemplary disclosed system and method are directed to overcoming one or more of the shortcomings set forth above and/or other deficiencies in existing technology.

### SUMMARY OF THE DISCLOSURE

In one exemplary aspect, the present disclosure is directed to a control system. The control system includes a voice recognition module, comprising computer-executable code stored in non-volatile memory, a processor, a voice recognition device, and a user interface. The voice recognition module, the processor, the voice recognition device, and the user interface are configured to use the voice recognition device to generate real-time user voice data, detect a first user command uttered beginning at a first time and a second user command uttered beginning at a second time based on the real-time user voice data, and move an element of the user interface in a first state for a first time period starting after the first user command is uttered and ending at the second time. The voice recognition module, the processor, the voice recognition device, and the user interface are configured to move the element of the user interface in a second state for a second time period starting at the second time and ending when an utterance of the second user command ends, and move the element of the user interface in the first state for a third time period following the second time period.

In another aspect, the present disclosure is directed to a method. The method includes using a voice recognition device to generate real-time user voice data, and detecting a first user command uttered beginning at a first time and a second user command uttered beginning at a second time based on the real-time user voice data. The method also includes moving an element of the user interface in a first state for a first time period starting after the first user command is uttered and ending at the second time, moving the element of the user interface in a second state for a second time period starting at the second time and ending when an utterance of the second user command ends, and stopping the element of the user interface when the second time period ends.

### BRIEF DESCRIPTION OF THE DRAWINGS

FIG. 1 is a schematic view of an exemplary embodiment of the present invention;

FIG. 2A is a schematic view of an exemplary embodiment of the present invention;

FIG. 2B is a schematic view of an exemplary embodiment of the present invention;

FIG. 2C is a schematic view of an exemplary embodiment of the present invention;

FIG. 2D is a schematic view of an exemplary embodiment of the present invention;

FIG. 2E is a schematic view of an exemplary embodiment of the present invention;

FIG. 2F is a schematic view of an exemplary embodiment of the present invention;

FIG. 3A is a schematic view of an exemplary embodiment of the present invention;

FIG. 3B is a schematic view of an exemplary embodiment of the present invention;

FIG. 3C is a schematic view of an exemplary embodiment of the present invention;

FIG. 4A is a schematic view of an exemplary embodiment of the present invention;

FIG. 4B is a schematic view of an exemplary embodiment of the present invention;

FIG. 4C is a schematic view of an exemplary embodiment of the present invention;

FIG. 4D is a schematic view of an exemplary embodiment of the present invention;

FIG. 5 illustrates an exemplary process of the present invention;

FIG. 6 is a schematic illustration of an exemplary computing device, in accordance with at least some exemplary embodiments of the present disclosure; and

FIG. 7 is a schematic illustration of an exemplary network, in accordance with at least some exemplary embodiments of the present disclosure.

### DETAILED DESCRIPTION AND INDUSTRIAL APPLICABILITY

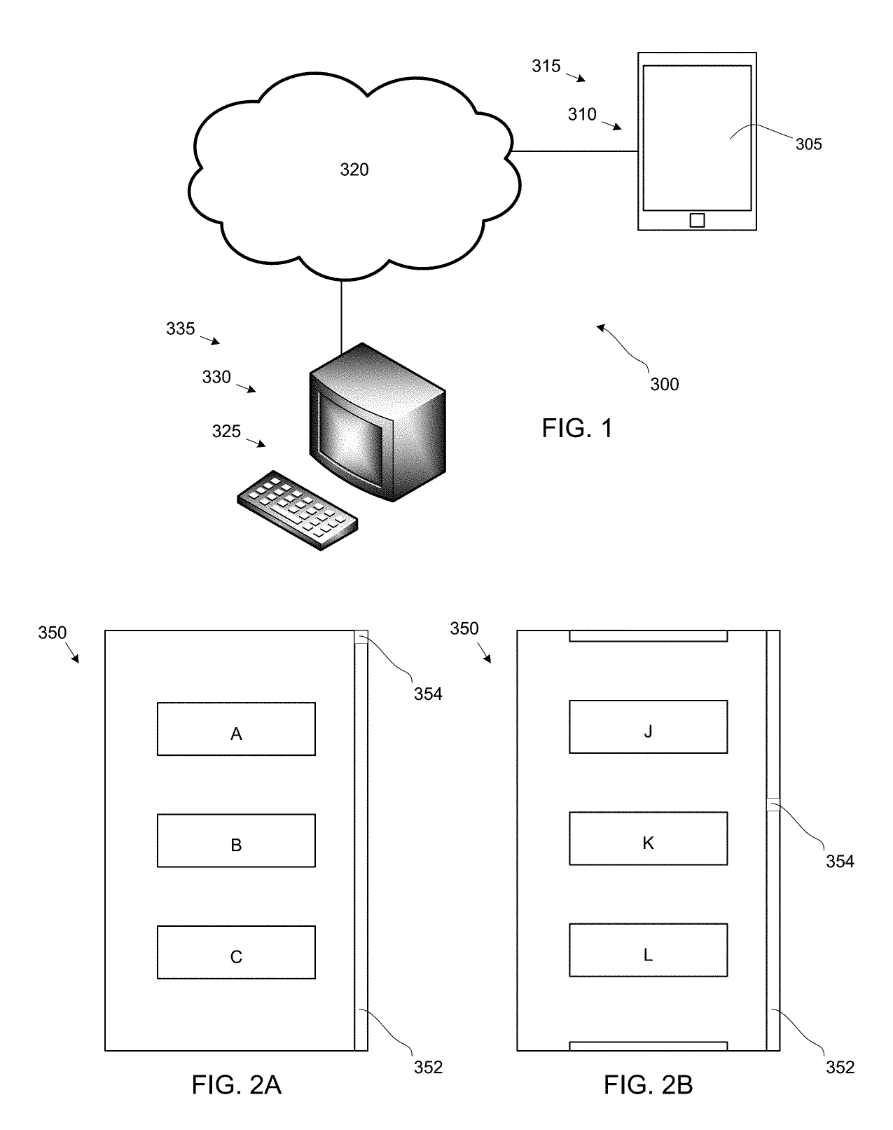

FIG. 1 illustrates an exemplary system 300 for voice control of a computing device. Exemplary system 300 may be, for example, any system for controlling a computing device. For example, exemplary system 300 may be any suitable system for controlling a user interface of a computing device such as, for example, operation of a graphical user interface. Also for example, exemplary system 300 may be any suitable system for controlling a cursor (e.g., and/or movable indicator or any other interface element) or other selection or control portion of a user interface to move across and/or select objects displayed on a graphical user interface (e.g., shift or move along any axis, path, or track relative to a first position). For example, exemplary system 300 may be any suitable system for controlling any suitable type of user interface and/or computing device control method such as, for example, a computer, a smartphone, a tablet, a smartboard, a television, a video game, a virtual reality application, a head up display for a car or other ground, air, and/or waterborne vehicle, a user interface for control of household items, a system of a commercial or industrial facility, and/or any suitable type of user interface and/or control method for controlling a computing device involving any suitable personal, residential, commercial, and/or industrial application.

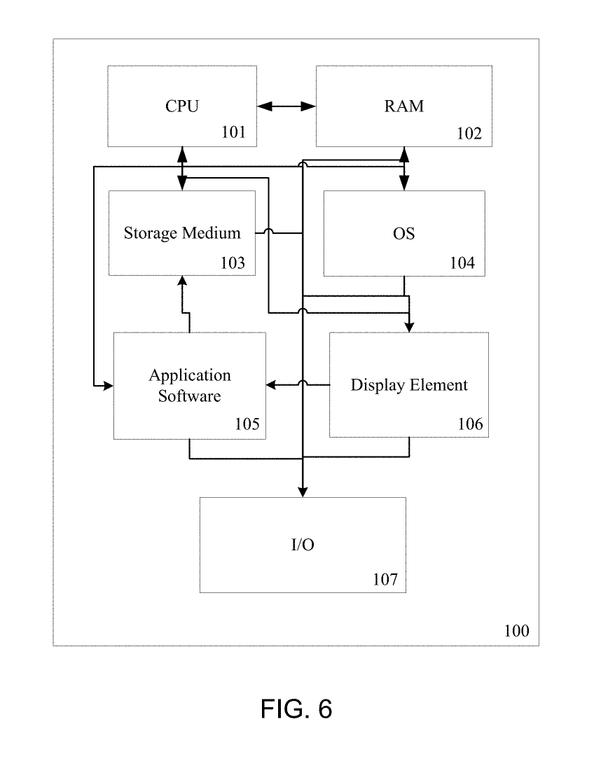

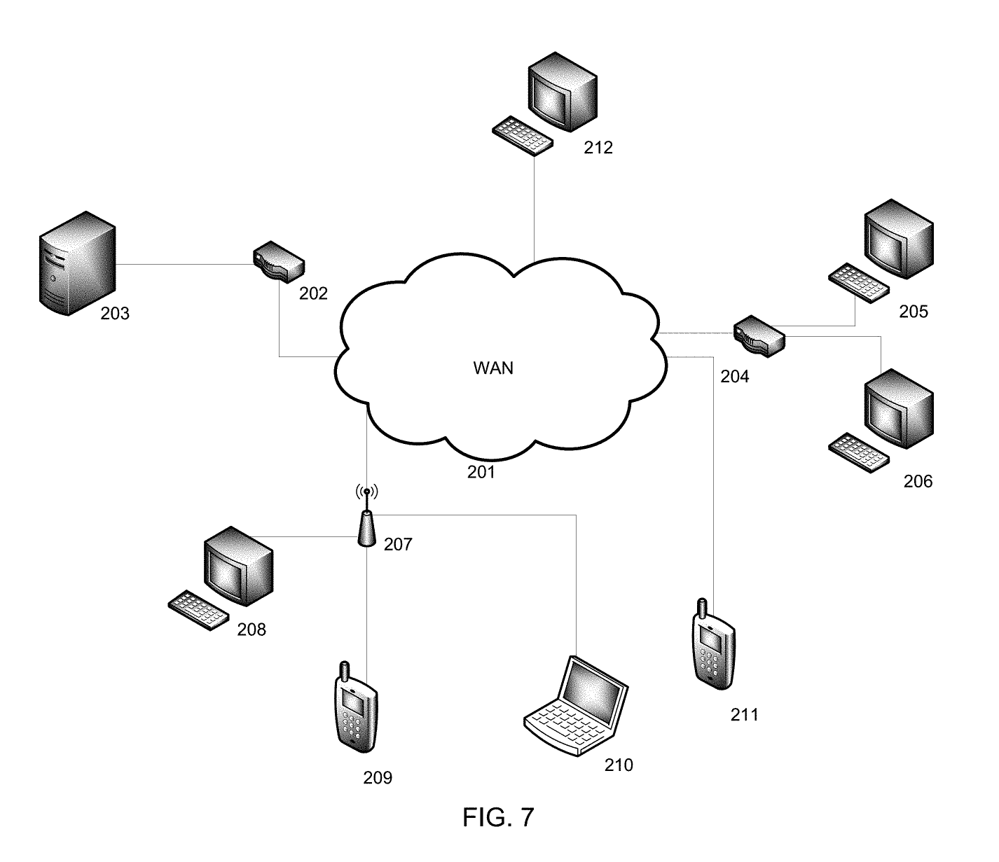

For example as illustrated in FIG. 1, system 300 may include a user interface 305, a voice recognition device 310, a processor, and a voice recognition module. As disclosed for example below, some or all of user interface 305, voice recognition device 310, the exemplary processor, and the exemplary voice recognition module may be part of (e.g., integrated into) a computing device 315 and/or in communication with other components of system 300 via a network 320. For example, components of computing device 315 may be similar to exemplary components of computing device 100 disclosed below regarding FIG. 6. Also for example, components of network 320 may be similar to exemplary components of network 201 disclosed below regarding FIG. 7.

User interface 305 may be any suitable device for allowing a user to provide or enter input and/or receive output during an operation of computing device 315. For example, user interface 305 may be a touchscreen device (e.g., of a smartphone, a tablet, a smartboard, and/or any suitable computer device), a computer keyboard, mouse, and/or monitor (e.g., desktop or laptop), and/or any other suitable user interface (e.g., including components and/or configured to work with components described below regarding FIGS. 6 and 7). For example, user interface 305 may include a touchscreen device of a smartphone or handheld tablet. Also for example, system 300 may include a computing device 335 including a voice recognition device 330 and a user interface 325 that may include a computer monitor, keyboard, and/or mouse.

The exemplary voice recognition module may comprise computer-executable code stored in non-volatile memory, which may include components similar to components described below regarding FIGS. 6 and 7. The exemplary processor may also include components similar to components described below relating to FIGS. 6 and 7. The exemplary voice recognition module, the exemplary processor, user interface 305, and voice recognition device 310 may operate together to perform the exemplary processes described further below. The exemplary voice recognition module and the exemplary processor may communicate with other components of system 300 via network 320 (e.g., as disclosed below regarding FIG. 7). The exemplary voice recognition module and the exemplary processor may also be partially or substantially entirely integrated into one or more components of system 300 such as, for example, computing device 315 and/or computing device 335. System 300 may include any suitable number of exemplary computing devices (e.g., such as computing device 315 and/or computing device 335).

The exemplary voice recognition module may operate in conjunction with the other components of system 300 (e.g., as disclosed below) to retrieve, store, process, and/or analyze data transmitted from an exemplary computing device (e.g., computing device 315 and/or computing device 335), including for example data provided by an exemplary voice recognition device (e.g., voice recognition device 310 and/or voice recognition device 330). For example, the exemplary voice recognition module may operate similarly to exemplary components and modules described below regarding FIGS. 6 and 7.

The exemplary voice recognition device (e.g., voice recognition device 310 and/or voice recognition device 330) may be any suitable device or system for recognizing human speech. For example, the exemplary voice recognition device may be any suitable device or system for interpreting human speech as commands (e.g., instructions spoken by a user) for carrying out actions desired by a user. For example, the exemplary voice recognition device (e.g., voice recognition device 310 and/or voice recognition device 330) may be an integral part of the exemplary computing device (e.g., computing device 315 or computing device 335), a standalone device, and/or integrated into any other suitable part of system 300.

For example, the exemplary voice recognition device may include an analog-to-digital converter that may convert vibrations (e.g., sound waves in the air) created by a user's speech into digital data. For example, the exemplary voice recognition device may digitize (e.g., sample) analog sound by measuring (e.g., precisely measuring) properties of a sound wave (e.g., at small intervals). The exemplary voice recognition device and/or exemplary voice recognition module may also include filtering components (e.g., or may be configured to perform a filtering operation) to filter digitized data (e.g., digitized sound data). For example, the filtering operation may separate the collected data into different groups based on frequency (e.g., based on wavelength of the measured sound wave) and/or to remove background noise such as non-speech noise. The exemplary voice recognition device and/or exemplary voice recognition module may also adjust the collected data (e.g., normalize the data) to account for differences in volume and/or speed of a user's speech.

Further for example, the exemplary voice recognition device may transmit the collected data to the exemplary voice recognition module, which may process the collected data. It is also contemplated that the exemplary voice recognition module may either include processing components and/or be partially or fully integrated into the exemplary voice recognition device. For example, the exemplary voice recognition module and/or exemplary voice recognition device may compare the collected data to an existing database of sound samples. Also for example, the collected data may be divided into small periods of time in order to identify language (e.g., to identify phonemes of any desired language for which data may be processed). For example, system 300 may be configured to identify and analyze any desired language and/or language groups (e.g., English, Korean, Chinese, German, Russian, Portuguese, and/or any other desired language).

Also for example, the exemplary voice recognition module and/or exemplary voice recognition device may perform speech recognition operations using statistical modeling systems that employ probability functions to determine a likely spoken word (e.g., by applying grammar and/or syntax rules of a given language). Further for example, system 300 may utilize prediction algorithms and/or artificial intelligence approaches that may include regression models, tree-based approaches, logistic regression, Bayesian methods, deep-learning, and/or neural networks.

The exemplary disclosed system and method may be used in any suitable application for controlling a computing device. For example, the exemplary disclosed system and method may be used to control a user interface of a computing device such as, for example, operation of a graphical user interface. For example, the exemplary disclosed system and method may be used to control a cursor or other selection or control portion of a user interface to move across and/or select objects displayed on a graphical user interface. For example, the exemplary disclosed system and method may be used for control of any suitable type of user interface and/or computing device control method such as, for example, a computer, a smartphone, a tablet, a smartboard, a television, a video game, a virtual reality application, a head up display for a car or other ground, air, and/or waterborne vehicle, a user interface for control of household items, a system of a commercial or industrial facility, and/or any suitable type of user interface and/or control method for controlling a computing device involving any suitable personal, residential, commercial, and/or industrial application.

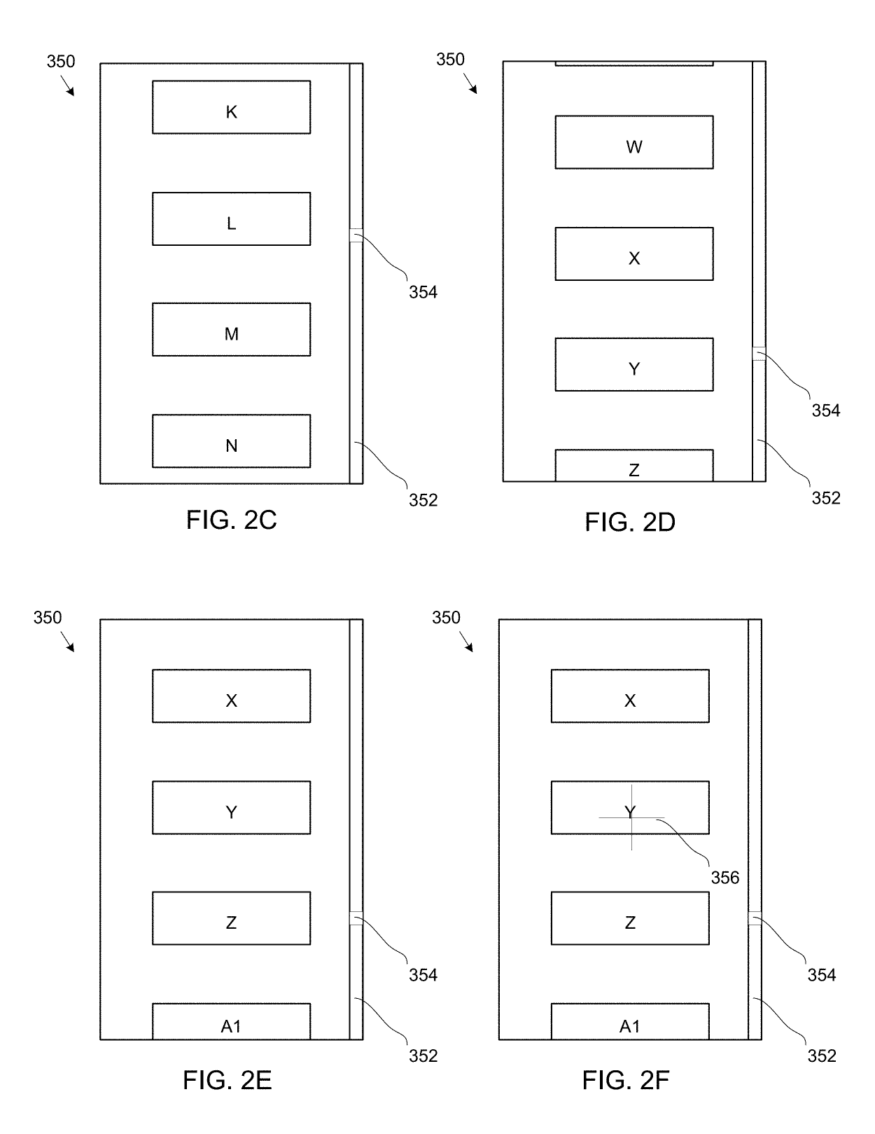

Examples of operation of the exemplary system and method will now be described. For example, FIG. 2A illustrates an exemplary user interface 350 that may be for example a graphical user interface that may be included in an exemplary computing device (e.g., similar to user interface 305 and/or user interface 325 included in computing device 315 and/or computing device 335, respectively). A user may for example control an operation of user interface 350 using voice commands. For example, a user may include operation of graphical user interface 350 to display elements to include, e.g., scrolling (e.g., scrolling up, down, left, and/or right), zooming, panning, rotating, pitching, yawing, and/or any other suitable movement. For example, a user may use voice commands to control manipulation of applications (e.g., word, spreadsheet, database, and/or other suitable types of operations), webpages and internet navigation, operations of displays such as entertainment media (e.g., television and/or video games), interfaces on vehicles, and/or any other suitable operations.

For example, system 300 may be a voice control interface that may control movement (scrolling, zooming, panning, rotating, pitching, yawing, and/or any other suitable movement) across a user interface (e.g., user interface 350). For example, a user may use voice commands to cause system 300 to move a screen, control a cursor, move a movable indicator, and/or control user interface 350 in any suitable manner. For example, a user may use voice commands as a technique of control that may be an alternative to control by hand (e.g., using a hand to move a mouse, strike a keyboard, and/or touch a touch board). For example, a user may use voice commands to control system 300 to make a selection and/or further inspect an item on an exemplary user interface (e.g., user interface 350).

For example, a user may utter one or more words that may be detected, processed, and/or analyzed by the exemplary voice recognition device (e.g., voice recognition device 310 and/or 330) and/or the exemplary voice recognition module as disclosed herein. For example, the exemplary system and method may increase voice-control versatility by allowing commands (e.g., predetermined commands) to have a plurality of states (e.g., two or more states) that may be carried out based on a single command (e.g., voice command or utterance). Also for example, a plurality of commands may be paired with each other (e.g., a command indicating a primary action and a command indicating a secondary action), e.g., to allow system 300 to anticipate a pending secondary action based on a second command after a primary action has been initiated by a first command. For example, a primary or first command may initiate a movement (e.g., “zoom,” “zoom in,” “scroll down,” “rotate left,” and/or any other command) and a secondary or second command (e.g., a sustaining command”) may adjust the action initiated by the first command as disclosed, e.g., below. For example as disclosed below, a user may use a secondary command to change a state of operation (e.g., speed up or slow down scrolling and/or make any other desired adjustment to an ongoing action). For example as disclosed in the exemplary embodiments below, a user may extend a primary action for as much time as desired before triggering a secondary action. Further commands may be also used in conjunction with the first (e.g., primary) command and second (e.g., secondary or sustaining) command.

Returning to FIG. 2A, user interface 350 provides an illustration of an operation of the exemplary system and method. For example, a user may use voice commands to control scrolling of user interface 350. For example, the exemplary system may utilize a primary command and/or a sustaining command having a plurality of states. For example, the exemplary system may utilize a primary command and/or a sustaining command including two or more speeds for an action such as scrolling (e.g., or any other suitable type of action such as, for example, zooming, panning, rotating, pitching, yawing, and/or any other suitable movement) for browsing a website menu or other formatted content. For example, the exemplary system may utilize a primary command and/or a sustaining command having two speeds (e.g., or more speeds) for continuous scrolling or movement of an indicator (e.g., such as a cursor or other suitable indicator for use on a graphical user interface). For example, a first speed (e.g., a default speed) may be any suitable speed that is fast enough (e.g., may scroll suitably swiftly enough) for skimming content (e.g., “quick scrolling”). Also for example, a second speed may be slower than the first speed (e.g., a fraction of the first speed). For example, the second speed may be suitable for reading and/or more careful inspection of content (e.g., “fine scrolling”). The sustaining command may also include other exemplary speeds such as a third speed (e.g., “very quick scrolling”) that is faster than the first speed, a fourth speed (e.g., “quick-fine scrolling”) that is between the first and second speed, and/or a fifth speed (e.g., “very fine scrolling”) that is slower than the second speed. For example, the first and second speed (e.g., and/or any other suitable speed such as the third, fourth, and fifth speed) can be customized by a user (e.g., of system 300). For example, the first and second speed may be customized as independent values or as a single value and a fraction (e.g., a fraction of the single value).

For example, a user may control system 300 by saying a first (e.g., primary) command and a second (e.g., secondary or sustaining) command. For example, a user may utter a primary command (e.g., such as “scroll down”) instructing system 300 to scroll down at a first speed (e.g., a “quick scrolling” speed). For example, based on a first (e.g., primary) command of “scroll down” uttered by a user, graphical user interface 350 may scroll down at a first speed (e.g., “quick scrolling”) from the display illustrated in FIG. 2A to the display illustrated in FIG. 2B. For example, feature 354 that may be a marker on a feature 352 that may be a scroll bar may move down from the position shown in FIG. 2A to the position shown in FIG. 2B. Also for example, objects (e.g., text, graphic, media such as video, and/or any other suitable interface element) such as those marked by letters in FIGS. 2A and 2B may move down on graphical user interface 350 at the first speed (e.g., a “quick scrolling” speed).

As the exemplary system continues to move (e.g., “quick scroll”) graphical user interface 350 downward, a user may say a second (e.g., sustaining) command. For example, the user may utter any suitable phrase (e.g., drawn-out voice command having a trailing tone) such as, e.g., “uhhh,” “ummm,” “hmmm,” “ermmm,” “mmm,” “euhhh,” and/or any other suitable vocal utterance common to a given language. For example, the second (e.g., sustaining command) may be any suitable vocalization used in a given language that may be utilized by system 300 and that may be sustained (e.g., maintained and/or drawn out) when uttered by a user. For example, the second (e.g., sustaining command) may be a monosyllable utterance that may be easily drawn out for a desired time period by a user. For example, the second (e.g., sustaining command, and/or any other exemplary commands disclosed herein) may rely on natural speech of a given language (e.g., rely on colloquial vocalizations, slang, and/or any other utterances commonly used in a given language).

For example, a user may utter an exemplary second (e.g., sustaining) command when graphical user interface 350 shows the display illustrated in FIG. 2B. In response to a start of the sustaining command (e.g., at the start of an utterance of “ummm”), the exemplary system (e.g., system 300) may change the state of an action from a first state to a second state. For example, system 300 may change (e.g., shift) the speed of scrolling from the first speed (e.g., “quick scroll”) to the second speed (e.g., “fine scroll”). System 300 may maintain the second speed (e.g., “fine scroll”) for as long as the utterance is maintained. For example, as long as a user continues to maintain the sustaining command (e.g., “ummm”), the exemplary system may continue to “fine scroll” at a second speed that is slower than the first speed (e.g., “quick scroll”). For example, a user may maintain the sustaining command (e.g., continue to say and draw out the vocalization “ummm”) while graphical user interface 350 moves at the second speed (e.g., “fine scroll”) from the configuration illustrated in FIG. 2B to the configuration illustrated in FIG. 2C. For example, the user may maintain the trailing portion of the sustaining command for any desired time interval, such as a second, a few seconds, or a portion of a minute (e.g., between about two seconds and about fifteen seconds, between about two seconds and about ten seconds, between about two seconds and about eight seconds, between about two seconds and about five seconds, and/or any other desired time period for maintaining a desired speed) or any other suitable time period. A user may use any suitable utterance that may be maintained for a desired period of time (e.g., a monosyllabic and/or multi-syllabic utterance that may be extended naturally and ended efficiently in a manner that is not cumbersome). For example, a user may naturally and easily use an utterance such as “ummm” to extend a sustaining command for as long as desired and to easily end the utterance when desired. For example, a user may cease uttering the sustaining command when graphical user interface 350 is at the configuration illustrated in FIG. 2C, at which point system 300 may change from the second speed back to the first speed (e.g., shift from “fine scrolling” back to “quick scrolling”). Accordingly, system 300 may resume the first action (e.g., first speed) at the termination of an utterance of the sustaining command.

After a user ceases saying the sustaining command (e.g., ceases saying “ummm” or any other suitable sustaining command), the exemplary system resumes moving at the first speed (e.g., “quick scroll”). For example, system 300 may resume scrolling down at the first speed (e.g., “quick scroll”) from the configuration of graphical user interface 350 illustrated in FIG. 2C to the configuration illustrated in FIG. 2D.

Further for example, a user may again utter the second command at any desired time to change the state of an action. For example when graphical user interface 350 is in the configuration illustrated in FIG. 2D, a user may again say the sustaining command (e.g., “ummm” or any other suitable vocalization) to shift a downward scroll speed from the first speed (e.g., “quick scroll”) to the second speed (e.g., “fine scroll”). The user may maintain the sustaining command for a desired period of time such as, for example, the period of time between the configuration illustrated in FIG. 2D and the configuration illustrated in FIG. 2E.

When graphical user interface 350 is in the configuration illustrated in FIG. 2E, a user may end the utterance of the sustaining command (e.g., finish saying “ummm” or any other suitable vocalization) and then substantially immediately utter another command to stop the action (e.g., “stop”). Also for example, system 300 may allow for a brief pause (e.g., a fraction of a second) before switching the state of the action from the second state back to the first state. For example, the exemplary system may pause for a fraction of a second before switching from the second speed (e.g., “fine scroll”) back to the first speed (e.g., “quick scroll”) when the utterance of the sustaining command has finished to give the user enough time to utter another primary command immediately following the end of the sustaining command so that the new primary command may occur while the action is still in the second state (e.g., so that the new primary command may take effect during, e.g., “fine scrolling”). Alternatively for example, system 300 may proceed without a pause. For example, immediately after ceasing the utterance of the sustaining command (e.g., “ummm” or any other suitable vocalization), the user may stop the action (e.g., stop the scrolling) by saying a command such as a new primary command such as “stop” (e.g., or “cease” or “end”) or other suitable vocalization that may be recognized by system 300. For example, a user may say “stop” when graphical user interface 350 is in the configuration illustrated in FIG. 2E, at which time a scrolling of graphical user interface 350 may stop.

Also for example, a user may utter a command such as another primary command (e.g., “select,” “okay,” and/or any other suitable command) to select an object on graphical user interface 350 to load (e.g., to take an action similar to “clicking” or “double-clicking” on a feature of graphical user interface 350). The user may utter the exemplary selecting command such as “select” substantially immediately following ceasing saying the exemplary sustaining command (e.g., “ummm” or other suitable vocalization), or at any other time during an operation of system 300 (e.g., a user may also utter an exemplary selecting command such as “select” during “quick scrolling”). For example, system 300 may load a feature at or closest to a center of graphical user interface 350 when a user utters a primary command (e.g., says “select”). For example as illustrated in FIG. 2E, system 300 may load a feature closest to a center of graphical user interface 350 (e.g., feature “Y”) when the exemplary command “select” is uttered. Also for example, system 300 may automatically select a feature closest to a center of graphical user interface 350 (e.g., or at any other predetermined location of graphical user interface 350 based on a programming of the exemplary voice recognition module) to load when the exemplary selecting command (e.g., “select”) is uttered. Further for example as illustrated in FIG. 2F, graphical user interface may include a feature 356 that may graphically indicate an object to be selected and that may be located at a predetermined location of graphical user interface 350 (e.g., at a center). For example, feature 356 may be a cross-hairs, box, field, and/or any suitable type of marker for indicating objects to be selected when a user utters the exemplary selecting command (e.g., “select”). For example when a user says the exemplary selecting command, any objects co-located with feature 356 may be selected (e.g., as illustrated in FIG. 2F, object “Y” may be co-located with feature 356 and may be selected when a user utters the exemplary selecting command).

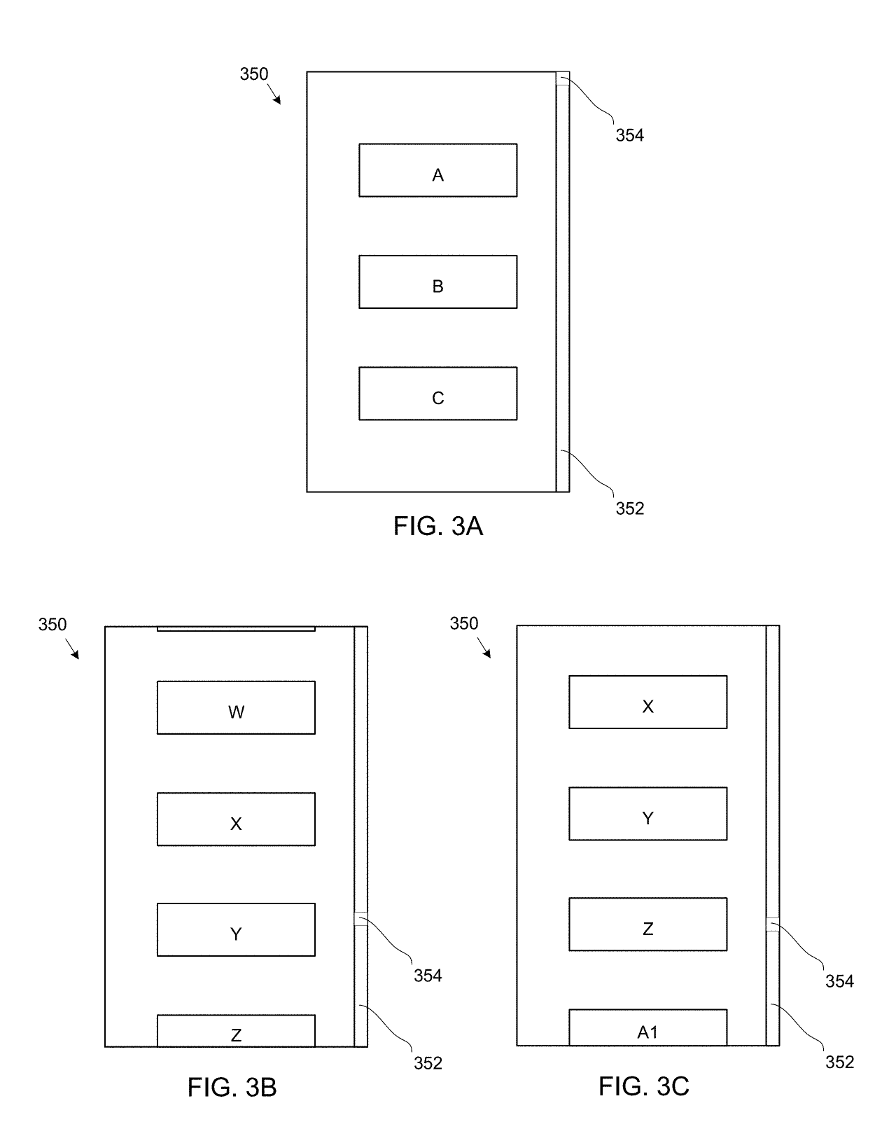

FIGS. 3A, 3B, and 3C illustrate another exemplary operation of the exemplary disclosed system and method. For example, based on a first (e.g., primary) command of “scroll down” uttered by a user, graphical user interface 350 may scroll down at a first speed (e.g., “quick scrolling”) from the display illustrated in FIG. 3A to the display illustrated in FIG. 3B.

When graphical user interface 350 shows the display illustrated in FIG. 3B, a sustaining command that may also serve as a consolidated sustaining command and second primary command may be uttered by a user. For example, a user may start uttering the exemplary sustaining command “stop” (e.g., or “cease,” “end,” and/or any other vocalization in any desired language based on a programming of the exemplary voice recognition module). The first part of the exemplary “stop” command may be drawn out (e.g., the user may maintain the utterance “stahhh . . . ”), which may serve as a sustaining command. In response to a start of the sustaining command (e.g., for the duration of an utterance of “stahhh”), the exemplary system (e.g., system 300) may change the state of an action from a first state to a second state. For example, system 300 may change (e.g., shift) the speed of scrolling from the first speed (e.g., “quick scroll”) to the second speed (e.g., “fine scroll”). System 300 may maintain the second speed (e.g., “fine scroll”) for as long as the utterance (e.g., of “stahhh”) is maintained. For example, as long as a user continues to maintain the sustaining command (e.g., “stahhh”), the exemplary system may continue to “fine scroll” at a second speed that is slower than the first speed (e.g., “quick scroll”). For example, a user may maintain the sustaining command (e.g., continue to say and draw out the vocalization “stahhh”) while graphical user interface 350 moves at the second speed (e.g., “fine scroll”) from the configuration illustrated in FIG. 3B to the configuration illustrated in FIG. 3C. For example, the user may maintain the trailing portion of the sustaining command for any desired time interval, such as a second, a few seconds, or a portion of a minute or any other suitable time period (e.g., as disclosed above).

System 300 may for example be configured to interpret the “stahhh” portion of the exemplary sustaining command as a first part of the command, and may monitor the user's voice and thereby anticipate an utterance of a ‘p’ sound to execute a stop command. For example, a user may complete the exemplary “stop” command when graphical user interface 350 is in the configuration illustrated in FIG. 3C. For example when the configuration illustrated in FIG. 3C is reached during the second speed (e.g., “fine scrolling”), the user may utter the “p” ending of the sustaining command to finish an utterance of the exemplary “stop” command and to end the utterance of the command. When the utterance of the exemplary “stop” command is finished when graphical user interface 350 is in the configuration illustrated in FIG. 3C, the exemplary system may stop scrolling. The user may then for example select object “Y” as disclosed above.

In at least some exemplary embodiments, a start of an exemplary sustaining command may be detected by system 300 by sampling audio input of a user while operating in a first state (e.g., while scrolling or moving an interface element at for example a desired speed as disclosed for example above) for any sustained tone within the range of human speech and at a volume loud enough to be differentiated from unintended input. For example, appropriate default levels may be set regarding loudness, pitch, tone consistency, and/or any other suitable factors to enhance accuracy while taking into consideration, e.g., any noise cancellation feature that may be involved (e.g., or lack of noise cancellation features). These parameters may also be for example customizable by the user via a settings menu or other technique provided by the exemplary user interface (e.g., user interface 305 and/or user interface 325). The exemplary voice recognition module and/or exemplary voice recognition device (voice recognition device 310 and/or voice recognition device 330) may for example detect vocal patterns of a user to help differentiate an exemplary sustaining command uttered by a user from any noise or other commands. It is also contemplated that any vocalization of a user may be interpreted by the exemplary system to be a sustaining command to change between states and to sustain (e.g., maintain) a desired state (e.g., as disclosed above).

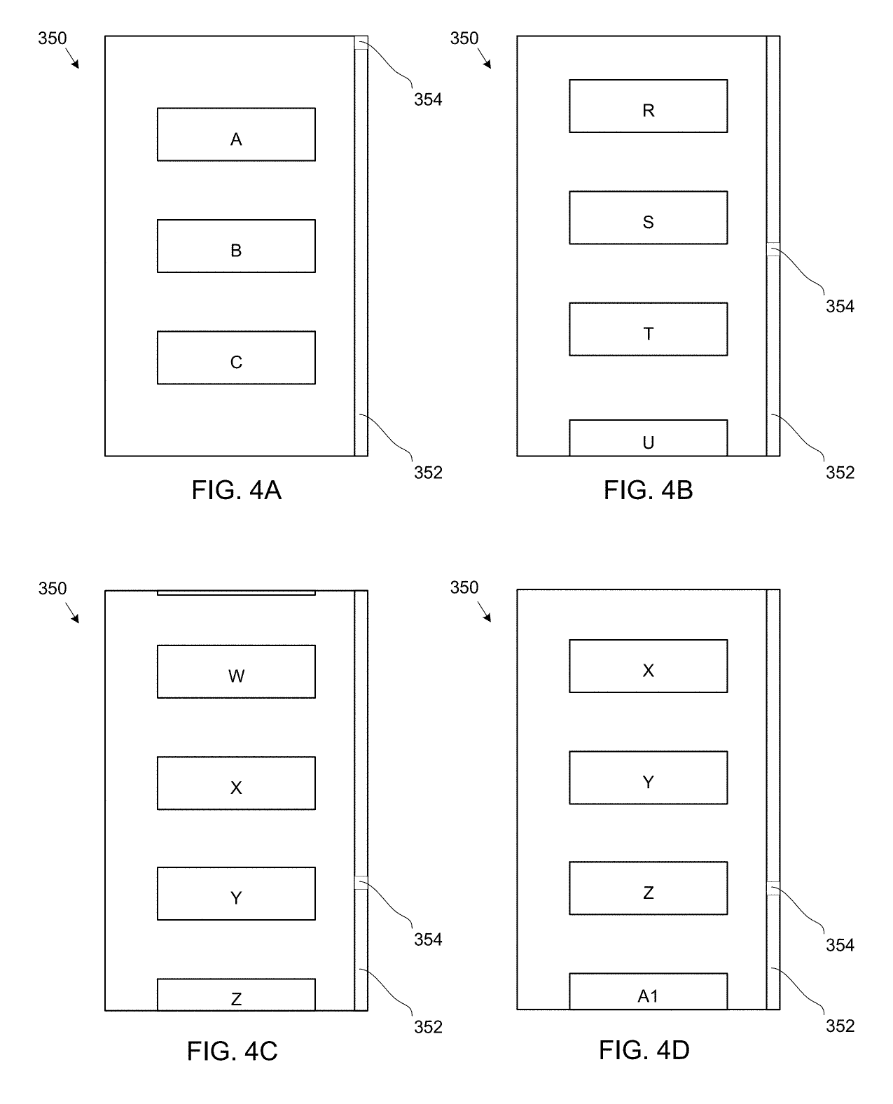

FIGS. 4A, 4B, 4C, and 4D illustrate another exemplary operation of the exemplary disclosed system and method. For example, based on a first (e.g., primary) command of “scroll down” uttered by a user, graphical user interface 350 may scroll down at a first speed (e.g., “quick scrolling”) from the display illustrated in FIG. 4A to the display illustrated in FIG. 4B.

When graphical user interface 350 shows the display illustrated in FIG. 4B, an additional primary command may be given to adjust the state of the exemplary system. For example, a user may utter the exemplary command “slower” that may adjust the scroll speed to a speed that is slower than “quick scrolling” but faster than “fine scrolling” such as, for example, “quick-fine” scrolling as disclosed, e.g., above. For example, the exemplary system may then instruct graphical user interface 350 to be scrolled downward at a “quick-fine” speed from the configuration of graphical user interface 350 illustrated in FIG. 4B to the configuration illustrated in FIG. 4C.

When graphical user interface 350 is in the configuration illustrated in FIG. 4C, a user may say an exemplary sustaining command (e.g., “ummm” or any other suitable vocalization) to shift a downward scroll speed from the previous speed (e.g., “quick-fine scroll”) to another speed (e.g., “fine scroll” that is slower than “quick-fine scroll”). The user may maintain the sustaining command for any desired period of time such as, for example, the period of time between the configuration illustrated in FIG. 4C and the configuration illustrated in FIG. 4D.

When graphical user interface 350 is in the configuration illustrated in FIG. 4D, a user may end the utterance of the sustaining command (e.g., finish saying “ummm” or any other suitable vocalization) and then substantially immediately utter another command to stop the action. For example, system 300 may allow for a brief pause (e.g., a fraction of a second) before switching the state of the action from the present state (e.g., “fine scrolling”) back to one of the other states (e.g., “quick-fine scrolling” or “fine scrolling”). For example, the exemplary system may pause for a fraction of a second before switching between states when the utterance of the sustaining command has finished to give the user enough time to utter another primary command immediately following the end of the sustaining command so that the new primary command may occur while the action is still in the previous state (e.g., occurs during a relatively precise state such as “fine scrolling”). Alternatively for example, system 300 may proceed without pausing. For example, immediately after ceasing the utterance of the sustaining command (e.g., “ummm” or any other suitable vocalization) the user may select an object by saying an exemplary selecting command (e.g., “select”). For example, a user may say “select” when graphical user interface is in the configuration illustrated in FIG. 4D, at which time object “Y” may be selected similar to as disclosed, e.g., above. For example, an object may be selected based on a command uttered immediately following the end of uttering a sustaining command.

The exemplary operation above illustrating scrolling provides exemplary embodiments that may also illustrate other operations involving for example, scrolling in any direction, zooming, panning, rotating, pitching, yawing, and/or any other suitable movement. For example, the exemplary disclosed system and method may encompass applications directed to any suitable control and/or operation of a graphical user interface, computer-implemented control device, and/or user interface such as, for example, graphical interface, smartboard, video game interface, virtual reality user interface, vehicle control interface (e.g., such as a head up display on a windshield or any other suitable portion of a vehicle), control interface for any facility (e.g., residential, commercial, and/or industrial facility, and/or any suitable type of user interface). For example, any suitable primary commands such as, e.g., “rotate left,” “zoom camera,” “pitch left,” “view starboard,” “toggle upward,” “spin clockwise,” and/or any other suitable command for controlling an interface.

For example, the exemplary system (e.g., system 300) may use the exemplary voice recognition device (e.g., voice recognition device 310 and/or voice recognition device 330) to generate real-time user voice data, and may detect a first user command (e.g., exemplary primary command) uttered beginning at a first time and a second user command (e.g., exemplary sustaining command) uttered beginning at a second time based on the real-time user voice data. The exemplary system may also move an element of the exemplary user interface (e.g., user interface 305 and/or user interface 325) in a first state for a first time period starting after the first user command is uttered and ending at the second time, and may move the element of the user interface in a second state for a second time period starting at the second time and ending when an utterance of the second user command ends. The exemplary system may also move the element of the user interface in the first state for a third time period following the second time period. For example, a duration of the second time period (e.g., a duration of a recitation of the sustaining command) may be substantially equal to a duration of time in which a user utters the second user command (e.g., exemplary sustaining command). Also for example, the user uttering the second user command may include the user sustaining (e.g., maintaining) a trailing tone of the second user command (e.g., maintaining a recitation of the exemplary sustaining command). The first state may be a first speed of movement of the element (e.g., “quick scroll” or “quick rotate”) and the second state may be a second speed of movement of the element (e.g., “fine scroll” or “fine rotate”), wherein the first speed may be faster than the second speed. The second user command may be a user voice command that may be exemplary sustaining commands such as uh (e.g., “uhhh”), umm (e.g., “ummm”), and/or hmm (e.g., “hmmm”). Also for example, the exemplary system may stop the element of the user interface when the second time period (e.g., recitation of the sustaining command) ends. In at least some exemplary embodiments, the second user command may include a first portion (e.g., a monosyllabic utterance having a trailing tone) and a second portion (e.g., the element may be stopped when the second portion of the second user command is uttered). Further for example, the second user command may be a user voice command selected from the group consisting of stop, cease, and end. Additionally for example, the element of the user interface may be moved in a second state for the second time period starting at the second time and ending within a fraction of a second after an utterance of the second user command ends (for example to slightly prolong the second state as disclosed, e.g., above). Also for example, either an object of the user interface may be selected or the element of the user interface may be moved in a third state when the third user command is uttered. For example, the third state may be a third speed of movement of the element that is slower than the first speed and faster than the second speed. Also for example, the third state may be a third speed of movement of the element that is faster than the first speed. Additionally for example, the second user command uttered again at a fourth time may be detected and the element of the user interface may be moved in the second state when the second user command is uttered starting at the fourth time.

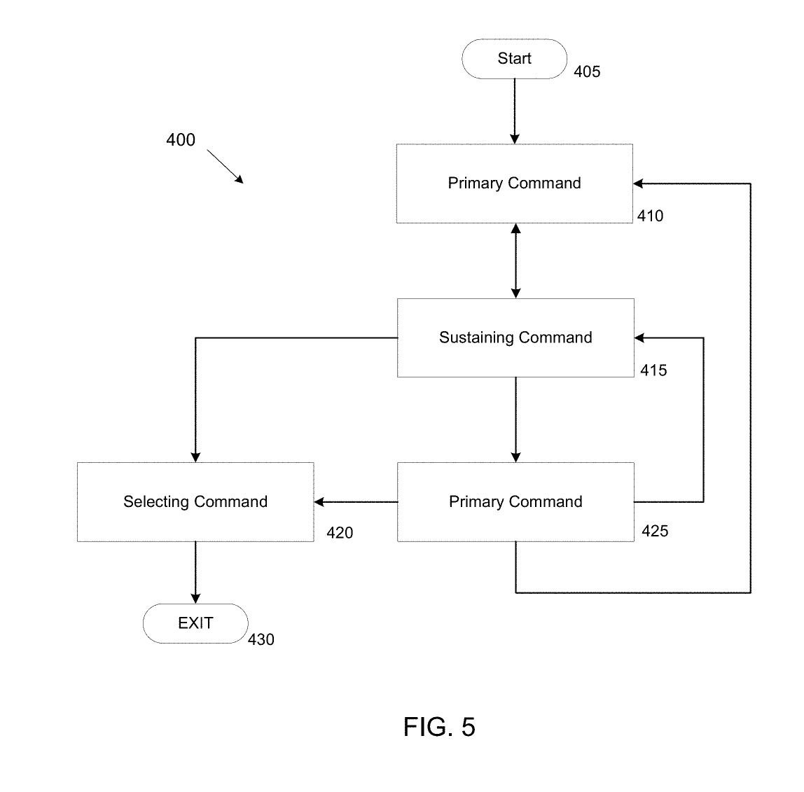

For example, FIG. 5 illustrates an exemplary process 400. Process 400 starts at step 405. At step 410, a user may say an exemplary primary command as disclosed for example above (e.g., “scroll,” “scroll down,” “rotate left,” “zoom camera,” “pitch left,” “view starboard,” “toggle upward,” “spin clockwise,” and/or any other suitable command in any language to initiate an action).

At step 415, a user may say a sustaining command as disclosed for example above (e.g., “uhhh,” “ummm,” “hmmm,” “ermmm,” “mmm,” “euhhh,” and/or any other suitable vocal utterance common to a given language). As disclosed for example above, a state of the action initiated by the primary command may change from a first state to a second state when the sustaining command is uttered. For example, if the primary command initiated a rotation of a feature of a graphical user interface, uttering the sustaining command may slow the speed of rotation of the feature from the first state (e.g., first speed) to a second state (e.g., second speed that is slower than the first speed). As disclosed for example above, a user may maintain (e.g., sustain a trailing vocalization) the sustaining command for any desired amount of time, thereby maintaining a second state (e.g., slower speed) of the action. A user may make a number of different actions following uttering the sustaining command at step 415. For example, immediately after uttering the sustaining command, the user may proceed to step 420 by uttering a selecting command for example as disclosed above (e.g., by uttering “select” or any other suitable selecting command). For example as disclosed above, a brief pause of a fraction of a second may occur following the end of uttering a sustaining command, in which the user may utter the selecting command at step 420 while the action is still in the second state (e.g., rotating a second speed that is slower than the first speed). Also alternatively for example, no such pause may follow uttering the sustaining command.

When the user has finished uttering the sustaining command at step 415, the user may also make no further utterance. If the user makes no further utterance after ceasing to say the sustaining command, system 300 returns to step 410 and the action returns to the first state (e.g., rotation or any other suitable action returns to the first state, e.g., a first speed that may be faster than the second speed). Step 410 may then proceed again to step 415 when a user utters the sustaining command. It is also contemplated that a user may utter a selecting command (e.g., “select”) and/or another primary command (e.g., “slower”) after uttering a primary command at step 410.

Also for example, when the user has finished uttering the sustaining command at step 415, the user may utter another primary command at step 425. For example, the user may utter a same primary command as the command at step 410, and/or a different primary command (e.g., “slower,” “faster,” “zoom,” and/or any other command that the exemplary voice recognition module may be programmed to recognize). At step 425, a user may again take any exemplary action disclosed above. For example after uttering another exemplary primary command at step 425, a user may utter a selecting command at step 420, utter another primary command at step 410, or utter a sustaining command at step 415. Process 400 may then continue per these exemplary steps as disclosed for example above. Process 400 may end at step 430 following uttering of an exemplary selecting command. It is also contemplated that process 400 may end at any point based on instructions said and/or entered by a user.

The exemplary disclosed system and method may provide an intuitively simple technique for controlling a computing device using voice control. For example, the exemplary disclosed system and method may provide a fluid voice control method allowing natural and substantially precise navigation, e.g., by utilizing commands having a plurality of states carried out by an utterance or command. As disclosed for example above, the exemplary disclosed system and method may anticipate a pending secondary action after a primary action is triggered, which may allow for flexible and natural control of a computing device. For example, the exemplary disclosed system and method may allow a user to extend an action such as a desired scrolling speed (e.g., or any other operation) for as much time as the user desires before triggering another action such as another scrolling speed (e.g., or any other operation).

An illustrative representation of a computing device appropriate for use with embodiments of the system of the present disclosure is shown in FIG. 6. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 7, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 7, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 7, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A control system, comprising:
a voice recognition module, comprising computer-executable code stored in non-volatile memory;
a processor;
a voice recognition device; and
a user interface;
wherein the voice recognition module, the processor, the voice recognition device, and the user interface are configured to:
use the voice recognition device to generate real-time user voice data;
detect a first user command uttered beginning at a first time and a second user command uttered beginning at a second time based on the real-time user voice data;
move an element of the user interface in a first state for a first time period starting after the first user command is uttered and ending at the second time;
move the element of the user interface in a second state for a second time period starting at the second time and ending when an utterance of the second user command ends; and
move the element of the user interface in the first state for a third time period following the second time period.

2. The control system of claim 1, wherein a duration of the second time period is substantially equal to a duration of time in which a user utters the second user command.

3. The control system of claim 2, wherein the user uttering the second user command includes the user sustaining a trailing tone of the second user command.

4. The control system of claim 1, wherein the first state is a first speed of movement of the element and the second state is a second speed of movement of the element, wherein the first speed is faster than the second speed.

5. The control system of claim 1, wherein the second user command is a user voice command selected from the group consisting of uh, umm, and hmm.

6. The control system of claim 1, wherein the second user command is a monosyllabic word pronounced with a trailing tone.

7. The control system of claim 1, wherein the second time period lasts from between about two seconds and about five seconds.

8. The control system of claim 1, wherein the user interface is a graphical user interface and the element is a graphical element of the graphical user interface.

9. The control system of claim 1, wherein the first user command is a user voice command including a word selected from the group consisting of scroll, zoom, pan, rotate, pitch, and yaw.

10. A method, comprising:
using a voice recognition device to generate real-time user voice data;
detecting a first user command uttered beginning at a first time and a second user command uttered beginning at a second time based on the real-time user voice data;
moving an element of the user interface in a first state for a first time period starting after the first user command is uttered and ending at the second time;
moving the element of the user interface in a second state for a second time period starting at the second time and ending when an utterance of the second user command ends; and
stopping the element of the user interface when the second time period ends.

11. The method of claim 10, wherein the second user command includes a first portion and a second portion.

12. The method of claim 11, wherein the first portion is a monosyllabic utterance having a trailing tone.

13. The method of claim 12, further comprising using a voice recognition module to recognize the monosyllabic utterance.

14. The method of claim 11, wherein stopping the element of the user interface includes stopping the element when the second portion of the second user command is uttered.

15. The method of claim 11, wherein the second user command is a user voice command selected from the group consisting of stop, cease, and end.

16. A control system, comprising:
a voice recognition module, comprising computer-executable code stored in non-volatile memory;
a processor;
a voice recognition device; and
a user interface;
wherein the voice recognition module, the processor, the voice recognition device, and the user interface are configured to:
use the voice recognition device to generate real-time user voice data;
detect a first user command uttered beginning at a first time, a second user command uttered beginning at a second time, and a third user command uttered beginning at a third time based on the real-time user voice data;
move an element of the user interface in a first state for a first time period starting after the first user command is uttered and ending at the second time;
move the element of the user interface in a second state for a second time period starting at the second time and ending within a fraction of a second after an utterance of the second user command ends; and
either select an object of the user interface or move the element of the user interface in a third state when the third user command is uttered.

17. The control system of claim 16, wherein the first state is a first speed of movement of the element and the second state is a second speed of movement of the element, wherein the first speed is faster than the second speed.

18. The control system of claim 17, wherein the third state is a third speed of movement of the element that is slower than the first speed and faster than the second speed.

19. The control system of claim 17, wherein the third state is a third speed of movement of the element that is faster than the first speed.

20. The control system of claim 17, wherein the voice recognition module, the processor, the voice recognition device, and the user interface are configured to detect the second user command uttered again at a fourth time and move the element of the user interface in the second state when the second user command is uttered starting at the fourth time.
